(19) United States
(12) Patent Application Publication
(10) Pub. No.: US 2011/0076126 A1
(43) Pub. Date: Mar. 31, 2011

(54) Device and Method for Palletizing Items

(75) Inventors: Cary Pierson, Clackamas, OR (US); Steve Heston, Clackamas, OR (US)

(73) Assignee: TOP TIER, INC., Clackamas, OR (US)

(21) Appl. No.: 12/893,073

(22) Filed: Sep. 29, 2010

Related U.S. Application Data
(60) Provisional application No. 61/247,497, filed on Sep. 30, 2009.

(51) Int. Cl. B65G 57/00

(52) U.S. Cl. 414/788.1

(57) ABSTRACT

An improved apparatus and method for palletizing bagged and other items that are susceptible to being damaged or degraded by the sliding friction caused by apron removal includes a center-opening apron assembly having a left and right side apron consisting of a roller curtain floor and belt. Each roller curtain floor follows a generally L-shaped path by means of roller chains guided through a plurality of sprockets. A single apron motor simultaneously operates both the left side and right side roller curtain by means of a cross-linked synchronization chain. Each roller curtain includes a belt having opposed stationary ends whereby opening of the roller curtain floor results in opposite direction rotation of the belt. This enables bagged items to by palletized in a single layer without causing bunching or tearing of the bagged items as the roller curtain floor retracts.

### FIELD OF THE INVENTION

The present invention relates to a palletizing device and method of use for palletizing stacks of bagged items or other items subject to degradation by frictional forces present during palletizing.

### BACKGROUND

The present invention contemplates an improved device and method for forming multiple tiers of stacked items, particularly for palletizing bagged items in various pre-determined configurations. Bagged items present challenges to palletizing operations that are not adequately addressed by known apparatus and systems adapted to palletize relatively rigid items such as boxed goods and the like. Because bagged items are not rigid, the bagged items sag and deform when handled, unlike cartons. For example, friction between the bag and the conveyor platform can cause a bag to bunch and a bag resting on a roller conveyor will sag between rollers. This distortion of bunching and sags can damage, tear or puncture the bag resulting in spoiled goods and/or causing damage to the material handling system resulting in reduced productivity, increased costs and waste. Additionally, due to the flaccid nature of bags in a palletizing system, multiple tiers of bagged items can become unstable further making stacking and securing a pallet load difficult.

Whether the items handled are bags or more rigid containers, palletizing generally refers to a process of constructing a stack of items organized as layers on a pallet. A pallet is a standard support and carrier structure used in shipping and provides a support surface for receiving items stacked for transport. Efficient shipping of palletized items calls for efficient stacking of items on the pallet to minimize open space within the stack. Accordingly, a variety of “item patterns” have emerged for efficient and stable packing together of items in item layers on a pallet. In some applications unit loads are built effectively identical to loads on pallets absent the pallet itself with a slip sheet providing load support or without any underlying support structure. Whether loads are built on pallets or without pallets, the common art name is palletizing.

Two common methods of palletizing consist of layer building palletizers and robotic pick and place palletizing. Layer building palletizers typically employ various mechanisms to manipulate items into rows of items spaced and turned appropriately to construct rows. Rows of items are then transferred to a layer assembly platform through various means until a layer is completed. Depending on the location of the of the layer assembly device, the completed layer is transferred to the load under construction. Typically the layer construction device has a layer support surface commonly called an apron. The apron can be rigid or flexible and in either style the apron is pulled from under the layer of items to deposit the layer on the pallet or previously deposited layer. Prior to deposit it is common to condition the layer that may be loosely assembled using various clamping means. Where the layer is assembled relative to the load under construction varies. Layers can be built horizontally offset then raised or lowered then moved horizontally for deposit. The layer can be assembled above the load under construction and either the layer assembly device is lowered to the load under construction for deposit or the load itself is raised to the fixed layer assembly device that opens to deposit the layer. A third method is to build less than complete layers that are transferred to the layer assembly device that vertically positions above the load under construction. All methods and techniques used are common in the art of layer building palletizing.

However, difficult challenges arise when palletizing bagged items. Because the bagged items do not have the structural rigidity of container, the contents of the bagged items flow and move. Thus, the bags tend to sag or bunch when moved. Recognizing these constraints, one attempt to provide specialized material handling equipment for bagged items includes a bag palletizing system and method described by Thomas R. Salts in U.S. Pat. No. 4,778,323 on 18 Oct. 1988. Salts describes an apparatus for assembling products such as bagged particulate material into a multi-tiered stack upon a pallet. The bagged articles are arranged into a tier upon an air table and then transferred to an elevator consisting of spaced parallel rollers. The elevator rises to a location above a set of retractable tines, which project beneath the elevator between the rollers. Transfer of the bagged items occurs as the elevator lowers.

Another attempt to palletize flaccid items includes the palletizing device for palletizing stacks of flat objects described by Fritz Achelpohl in U.S. Pat. No. 5,803,706 issued on 8 Sep. 1998. Achelpohl teaches delivery of stacks of flat items from a supply conveyor. The layer to be stacked is ejected from the support surface by a release motion of the support device while retaining the stacking pattern of the stack. The supply conveyor is formed from two conveyor belts, which are separately controllable and positioned in alignment with each other in a common plane parallel to the support device.

Other known attempts to palletize bagged items include robotic pick and place that uses a programmable mechanism to pick and place an item, item groups or previously constructed layers from a picking location to pallet load under construction. Unless the layer was previously constructed by other means, the pick and place device picks and places items into their finished position on the load under construction. A characteristic of such pick and place actions is the item or items are picked in such a manner that the actual gripping device does not hinder final positioning of items or items on the load.

Bags are typically handled with a basket style gripper that surrounds the bag in a clamp including supporting a substantial part of the bag bottom. The basket gripper opens dropping the bag into position onto the load under construction from an elevation allowing clearance for the basket to open. Dropping the bag is often preferred as dropping allows the pliable bag content to deform to the previously deposited bags creating a tighter load. Because the bag is contained in the basket and final placement accuracy is less critical the pick and place device often can operate at higher speeds than the same pick and place device will operate with previously discussed item or items handling devices. Often speeds are 20% faster when an identical programmable item pick and place device is assembling an identical pattern of bags compared to rigid containers indicative of the advantage of bottom support and less accurate final positioning provides. The second differentiating method of pick and place palletizing is full layer handling. Commonly the full layer is preassembled by various means into a tight configuration then the layer is picked and placed using top vacuum, side clamping or bottom support means so that the layer can be picked and place onto the load. Some bottom supporting methods will receive a loosely assembled layer and perform secondary layer conditioning into a tight configuration during the pick and place cycle.

Despite the aforementioned attempts to palletize bagged items, there remains a need for an improved device and method for palletizing bagged items that provides a uniform apron surface to build a layer for palletizing the entire layer and yet overcomes the limitations of existing palletizing devices and methods, particularly where bagged or similarly delicate items are palletized. Further, an improved bag-handling and palletizing system should provide little or no relative movement between the apron supporting surface and the underside of whatever is being palletized when the apron is removed to transfer the build layer to the pallet stack area.

Further, there remains a need for a palletizing devices and methods that improve total load throughput speeds, reduce complexity of components, maintain or improve upon a compact footprint and that can provide the benefits of more effective concurrent stretch wrapping. There is a need for a hybrid palletizer adapted to overcome the limitations of the known state of the art and provide a palletizing solution that is smaller, faster, and lower cost (to manufacture, operate, and maintain) compared to the current devices.

The present invention provides a uniform apron surface to build a layer for palletizing the entire layer and thus overcomes the limitations of existing palletizing devices and methods, particularly where bagged or similarly delicate items are palletized. Bagged items, as in most palletizing operations, are arranged in a particular layer arrangement on a layer build apron. The layer of items is clamped from at least two directions, and preferably four directions, then the supporting apron surface slides out from under the layer.

The present invention overcomes known problems associated with clamping and sliding operations utilized in existing palletizing devices and methods for unstable products such as bags or products with delicate exteriors such as poly wrapped cases that can be damaged by the sliding friction that occurs upon removal of an apron from beneath the bags or other products that are susceptible to degradation resulting from apron removal sliding friction. The present invention also overcomes the known limitation of exiting systems wherein sliding friction results in flexible containers (such as bags and other goods) to be urged against a restraining barrier, which distorts the bag content to the detriment of building a uniform load.

In the present invention, when the apron is removed there is no relative movement between the apron supporting surface and the underside of whatever is being palletized. The present invention, therefore, overcomes problems common to existing palletizing devices particularly applied to bagged items.

A palletizing system and method utilizing an improvement according to the present invention has significant commercial value. For example, such a system will reduce damage to handled items and increase throughput time due to reduced shut-downs from damaged items.

Another advantage of the present invention is its adaptability to existing palletizing system that use sliding aprons. Further, the present invention is well-adapted to pick and place robotic systems, whether already in use or in newly designed palletizing systems.

### BRIEF DESCRIPTION OF THE DRAWINGS

The invention will be better understood and its numerous objects and advantages will be apparent by reference to the following detailed description of the invention when taken in conjunction with the following drawings.

In FIGS. 1, 2 and 3 the belts that are part of the apron assembly and which covers the roller supports to define a uniform surface are removed to expose the component parts of the apron assembly, including the roller supports on both sides of the assembly.

FIG. 1 is a frontal perspective view of a first preferred embodiment of an improved apparatus for palletizing bagged items according to the present invention. In FIG. 1 the roller curtains are in their closed positions and the clamping arms that are part of a bagged item clamping system are shown in partially closed positions.

FIG. 2 a frontal perspective view of the system illustrated in FIG. 1showing the roller curtains in their closed positions and the clamping arms in open positions.

FIG. 3 is a frontal perspective view of the system shown in FIGS. 1 and 2 illustrating the roller curtains in their open positions and the clamping arms in open positions.

FIG. 4 is a frontal elevation view of the system illustrated in FIG. 1 with frame structures omitted, with the belts of the apron assembly included and showing the roller curtains in their closed positions.

FIG. 5 is a frontal elevation view similar to FIG. 4 except showing the roller curtains in their open positions.

### DETAILED DESCRIPTION OF THE PREFERRED EMBODIMENTS

Possible preferred embodiments will now be described with reference to the drawings and those skilled in the art will understand that alternative configurations and combinations of components may be substituted without subtracting from the invention. Also, in some figures certain components are omitted to more clearly illustrate the invention.

A known device that exemplifies the level of skill and understanding of those in this art includes the article handling device and system as described by Heston in U.S. Pat. No. 6,533,533 issued on 18 Mar. 2003, the entire contents of which are incorporated herein by this reference.

As would be well-appreciated by those skilled in the art, an improved device and method for palletizing bagged items and other items that are susceptible to being damaged or degraded by the sliding friction caused by apron removal, such as the various preferred embodiments according to the present invention, would adapt to work with existing pallet transfer, pallet load, and/or pallet wrapping systems as currently used in this field. Equally likely, the preferred embodiments of the present invention can readily incorporate into new systems from the design stage as an integrated solution for palletizing bagged items. Thus, while preferred embodiments refer to “bagged items,” it will be understood that the principles of the invention apply to any goods that can be palletized, but especially to goods that are susceptible to being damaged or degraded by the sliding friction caused by apron removal.

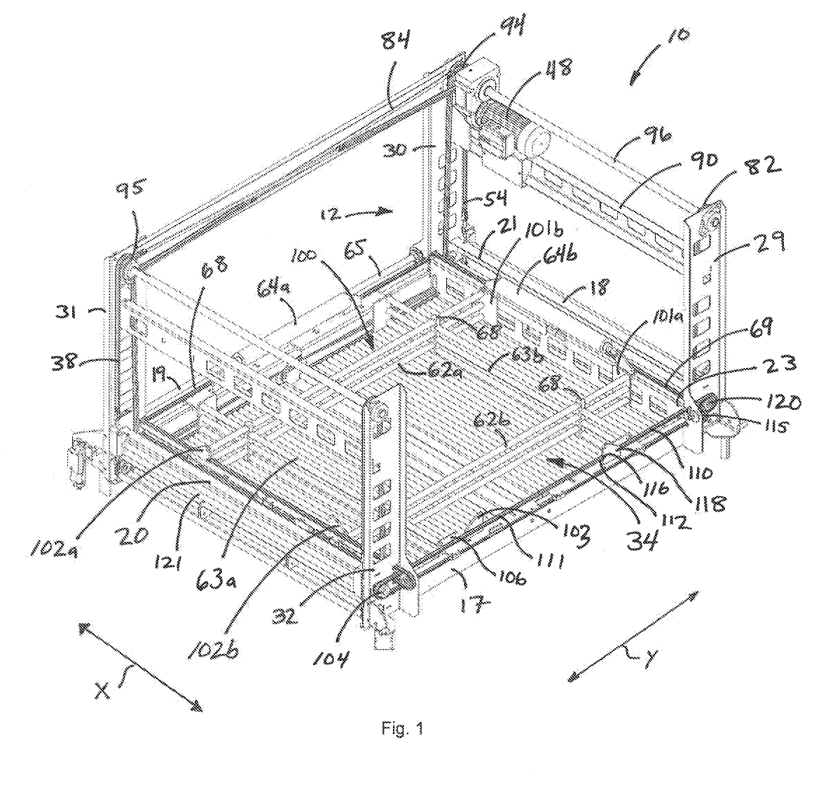

FIGS. 1-5 illustrate a first preferred embodiment of the present invention, which comprises a device 10 for palletizing bagged items having a frame 12 having a base structure defined by four rectilinearly arranged generally horizontal frame members wherein each pair of adjacent members form a generally right angle and each oppositely spaced pair of members are generally parallel. Thus, a first horizontal frame member 17 couples to a second horizontal frame member 18, forming a right angle, the second member 18 couples to a third frame member 19 at a right angle, and so on with the fourth frame member 20. All four of the horizontal frame members lie substantially in a common plane. A corresponding vertical member extends from each of the respective four corners. Thus a first vertical member 29 extends vertically from the first corner 23 formed by the adjacent first horizontal member 17 and second horizontal member 18 and so on with the second, third, and fourth vertical members 30, 31, and 32 respectively. At an end opposite the respective corresponding corner, or at any intermediate position between opposite ends of a given vertical member, reinforcing members may attach to link and further stabilize the frame. Such support arms or reinforcing members may align substantially horizontally, arranging parallel to the associated horizontal frame member.

A support arm, or cross member 90 extends horizontally between vertical members 29 and 30 of the frame 12. Mounted to this cross member 90, an apron motor 48, such as a Leeson worm drive gear motor, includes a drive shaft 96 and sprockets mounted at each end of drive shaft 96. A pair of apron synchronization roller chains transfer the rotation of the shaft 96 to roller chains via oppositely mounted drive shaft sprockets 94 and 82. For example, synchronization chain 84 shares this sprocket 94 and apron floor chain 54 is driven by a second sprocket adjacent to sprocket 94 (although not shown clearly in the figures) whereby clockwise rotation of the motor 48 output drive shaft translates to clockwise rotation of the sprocket 94 and clockwise motivation in the chain 84. (Herein, references to “clockwise” are made from the perspective of a viewer looking at FIG. 1.) Conversely, reversing the motor 48 in an anti-clockwise direction results in a similar anti-clockwise rotation of sprocket 94 and anti-clockwise motivation of the synchro chain 84. The synchro chain 84, a continuous loop chain, or preferably, an assembly consisting of two short chains connected by two rods that can cross in the center without conflict and arranged in an crossed or “x” pattern and is supported at one end by sprocket 94 and by a similar associated oppositely positioned gear sprocket 95 coupled to the oppositely disposed third vertical member 31. It will be appreciated that because synchro chain 84 is crossed in an x-pattern between sprockets 94 and 95, when sprocket 94 is rotated in the clockwise direction sprocket 95 is rotating in the opposite, anti-clockwise direction, and vice versa. At the opposite end of the drive shaft 96, a similar synchronization sprocket 82 drives a second synchronization chain arranged in a cross pattern (not shown in the drawing). And, adjacent to the synchro sprocket 82, a second roller curtain chain sprocket drives a second roller chain (both not shown in drawing). Thus, both sides of one apron floor are synchronized and both sides of the roller curtain floor are pulled by their own respective drive chains as detailed below.

The various synchronization chains and carrier shafts with associated drive chains enable a single motor to motivate the opening and closing of the apron floor and the associated belts. Synchronization, for example, occurs when clockwise rotation of sprocket 94 results in anti-clockwise rotation of sprocket 95. This cross-synchronization enables the apron (to be discussed in detail further herein) to have a center opening feature whereby two apron halves meet in the middle of the apron area when closing and open from the same centerline.

In the first preferred embodiment of the present invention, an apron 34 assembly comprises two apron halves: for convenience this document refers to each apron half as the left side apron 34a or right side apron 34b, respectively. The two apron halves are center-opening; that is, their respective leading edges meet near the center of the entire apron assembly as shown in FIG. 1 and each portion component is mirrored in the opposite half. A center-meeting, two-halved (dual) apron assembly is preferred to reduce cycle time for depositing an apron layer on a pallet and further takes less horizontal and vertical space in the palletizing system. However, an apron having a single assembly would work equally well in systems where a center-meeting dual apron assembly would not be practicable or where cycle times of the palletizer are less critical.

Apron assembly 34 comprises various components that in combination define the retractable support floor upon which plural individual bags to be palletized are collected and arranged prior to being deposited in layers on a surface such as a pallet or a slip sheet that is, in use, oriented vertically below the apron assembly. The pallet is not illustrated in the drawings but will be understood as being oriented below the apron assembly. As detailed below, after one layer of bagged items is arranged in a desired orientation on the apron assembly with the assembly in the closed position, and the bagged items are compacted or consolidated as desired with a compaction system, the apron is opened and the layer of bags is deposited on an underlying pallet.

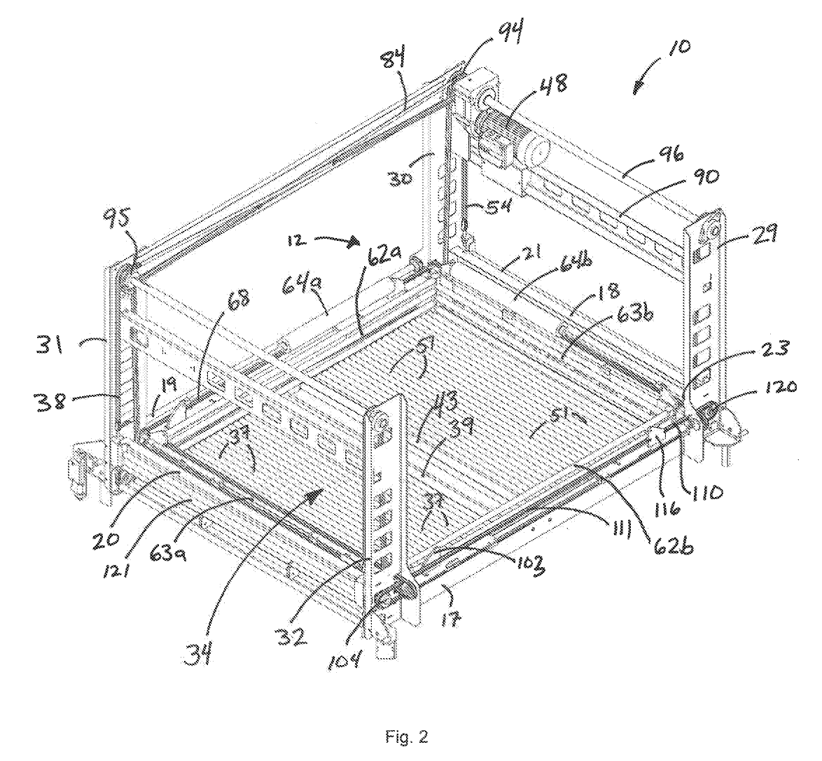

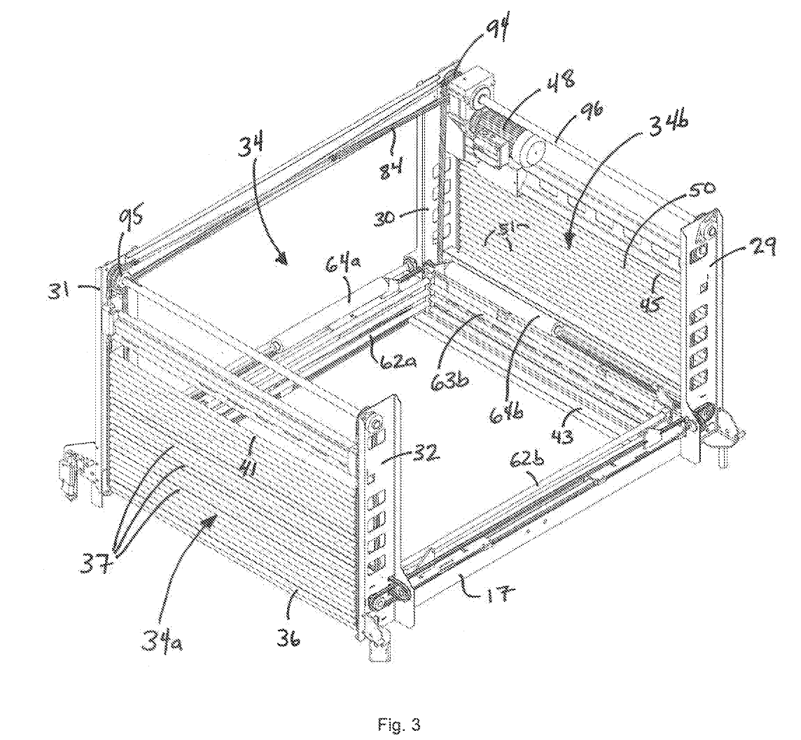

Left side apron 34a is defined by a roller curtain, or support curtain, shown generally with reference number 36 and a belt identified with reference number 44. Right side apron 34b is a mirror image of right side apron 334a and is thus similarly defined by a roller curtain shown generally with reference number 50 and a belt identified with reference number 58. As noted previously, belts 44 and 58 are removed from FIGS. 1, 2 and 3 in order to illustrate the other components of the apron assembly 34. With reference to FIG. 2, roller curtain 36 is defined by plural roller support members 37 that extend laterally across frame 12 along the x axis, transverse to the movement path of the roller curtains as they reciprocate along the y axis between closed and open positions. The plural roller support members 37 have their opposite ends attached to roller chains that cause the roller curtain to move between the closed position (FIG. 1) and the open position (FIG. 3) and are thus supported on both ends of the members. Roller curtain 36 thus comprises numerous roller support members 37 arranged parallel to one another and closely spaced from one another to define a relatively uninterrupted support platform having minimal space between the supports. Each roller support member 37 is independently rotatable about its attachment at its opposite ends to the roller chains. Roller curtain 50 is similarly defined by plural roller support members 51 that extend laterally across frame 12 and have their opposite ends attached to roller chains that cause the roller curtain to move between the closed position shown in FIG. 1 and the open position illustrated in FIG. 3. As with roller supports 37, each roller support member 51 is independently rotatable about its attachment at its opposite ends to the roller chains. The plural roller support members 51 likewise are arranged parallel to one another (and the roller support members 37) to define a uniform, uninterrupted support platform.

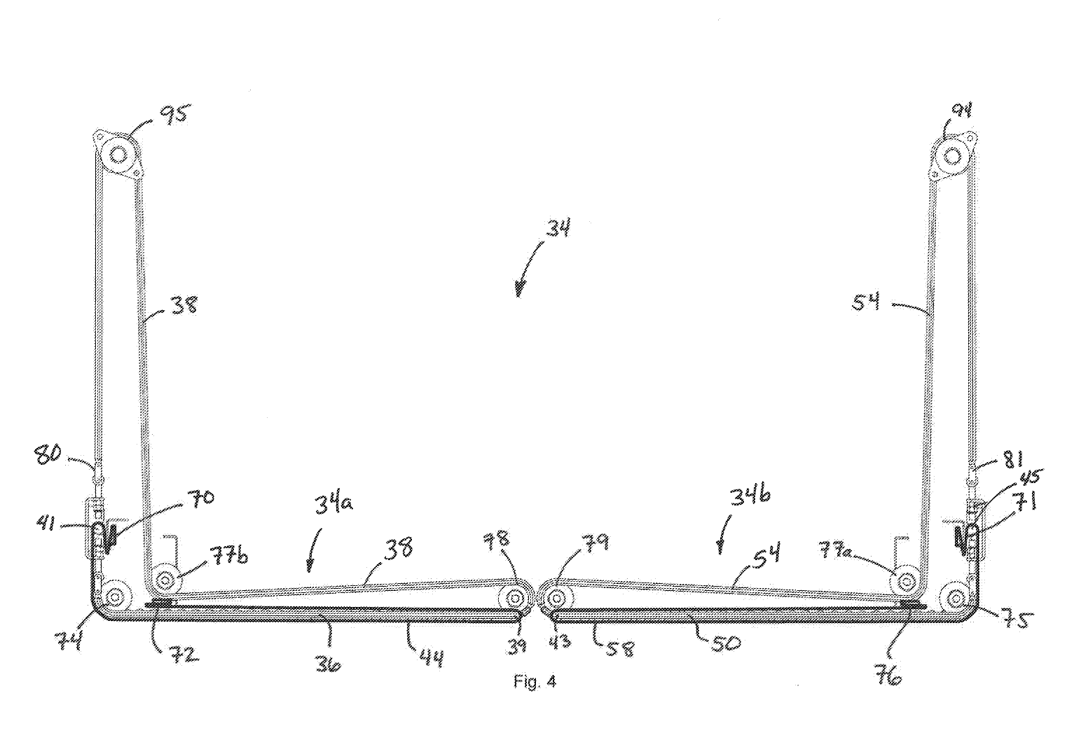

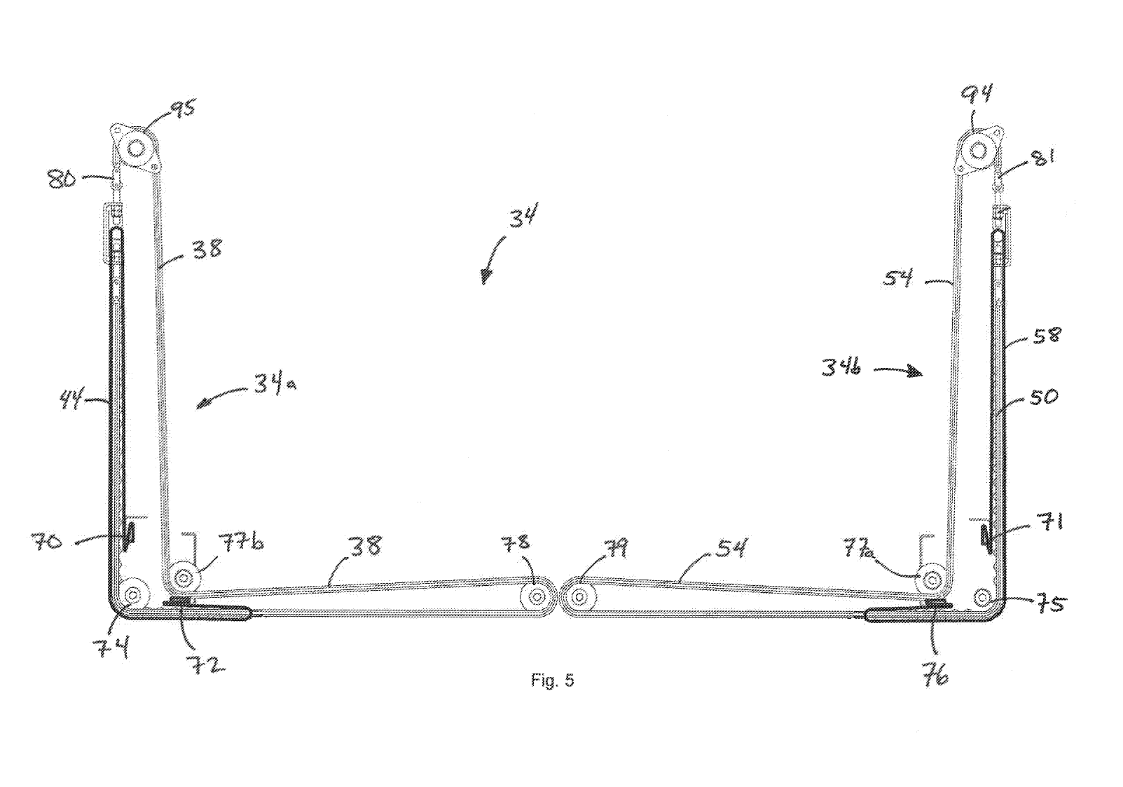

It will be appreciated that while the illustrated embodiment described above shows the roller members 37 and 51 and rotatably attached at their opposite ends, other non-rotatable support members will work just as well so long as the aprons 34a and 34b are flexible in the direction transverse to the y-axis so that the aprons can move through the L-shaped path shown in FIGS. 4 and 5. For example, roller members 37 and 51 may be equivalently replaced with struts or slats that have their opposite ends attached to the roller chains. Similarly, the support members may be replaced by a solid surface made of multiple pieces that are hinged to one another in the manner of a garage door or roll-up type security doors. Finally, the invention further contemplates aprons defined by solid support members about which a belt translates, although a solid support member would not move through an L-shaped path.

Left side apron 34a further includes a nose bar 39 positioned at one side of the support members 36 and having its opposite ends attached to the chain (see FIG. 2), and a nose bar 41 at the other side of the roller curtain (FIG. 3). The nose bars 39 and 41 define the leading and trailing edges of the roller curtain 36 as the roller curtain moves from open to closed, and vice versa, and define a smoothly curved surface around which belt 44 translates as the roller curtain moves. Because right side apron 34b is a mirror image of left side apron 34a, right side apron 34b includes a nose bar 43 positioned at one side of the roller curtain 50 and having its opposite ends attached to the chain (FIG. 2), and a nose bar 45 at the other side of the roller curtain (FIG. 3).

As stated, the left 34a and right 34b sides of the apron assembly are essentially identical, and their respective operation mirrors the opposite side. Also, as stated, this simultaneous, mirrored operation of the left-to-right sides of the apron is enabled by the cross-linked synchronization roller chain 84, which is driven by the single apron motor 48.

Making particular reference to the arbitrarily named left-side apron components of the apron assembly 34, sprocket 95 couples to the apron motor 48 via the cooperation of the synchronization chain 84, which is driven by sprocket 94, which, in turn, couples to the output drive shaft of the apron motor 48. As noted, clockwise motivation of the apron output drive shaft results in anti-clockwise rotation of sprocket 95. A first apron roller chain 38 rides on sprocket 95 and arranges generally vertically extending downward from the top end of the vertical member 31. As best illustrated in FIGS. 4 and 5, first bottom guide sprocket 77b redirects the roller chain 38 horizontally at about a 90-degree turn toward the center of the frame 12 until the chain reaches a center guide sprocket 78. The chain 38 makes an about 180-degree turn about the center guide sprocket 78 and returns outwardly (away from the center of frame 12) to a return guide sprocket 74. The chain turns once again about 90-degrees at guide sprocket 94 and is directed vertically upward to extend back to sprocket 95.

This continuous loop path creates a generally recognizable non-linear, L-shaped circuit. Roller curtain 36, which as noted above is defined by plural support members 37, is coupled to chain 38. Thus, each roller support member 37 has its opposite ends rotatably coupled to and supported by the chain 38. Movement of chain 38 in either direction corresponds directly to the positioning of the roller curtain, therefore, this L-shaped path enables a compact horizontal and vertical area for the associated first roller curtain 36 to reciprocate from an open position (as FIG. 3 illustrates, for example) to a closed position (as FIG. 2 illustrates, for example). When the left side roller curtain 34a is in the closed position the left side roller curtain is fully extended in a horizontal plane and reaches the center of the apron assembly 34 (cooperating with the right side that mirrors the left side operation, as will be discussed below). Conversely, the open position indicates that the roller curtain 36 is retracted from the center of the apron 34 and extends vertically into the upper portion of the L-shaped path created by the continuous loop first roller curtain chain 38. Further, although the roller curtain chain 38 is a continuous loop roller chain, in operation the chain is driven from the open position to the closed position and back again and reciprocates between these two extreme positions (or any intermediate position) according to a predetermined sequence programmed into a PLC controller. It is apparent that the left and right side roller curtains 34a and 34b reciprocate along a path defined by the directions shown in FIG. 1 as the x and y axes and accordingly the x and y axes thus define the movement path of the roller curtains.

The first roller chain 38 further preferably includes a tensioning member 80 for mechanical adjustment of the chain tension, as would be well-appreciated by those of ordinary skill in this art.

With returning reference to FIGS. 4 and 5, one key aspect of this first preferred embodiment of the present invention includes a first belt member 44 that defines the floor on which bagged items are supported on apparatus 10, and which defines a uniform sheet that substantially covers the roller curtain 36 so that there are no void spaces in the support surfaces defined by each belt. Belt 44 is generally the same width and, as shown in FIG. 4, is about twice the length as roller curtain 36. The belt 44 is not attached to the roller chain 38 in any way and is connected at its four corners to four fixed points on the frame 12. The attachment at the four corners of the belt to the frame 12 preferably includes some minor squaring adjustments, although structures for squaring the belt are not shown in the drawings other than schematically. The belt 44 follows the roller curtain 36 as the roller curtain moves and presents a surface relative to bagged items supported on the curtain assembly 34 that is stationary relative to the bagged items.

As the apron assembly 34 is moved between the closed position of FIG. 4 and the open position of FIG. 5, the belt is forced to follow the apron due to fixed mounting points between the four corners of the belt to the frame 12, with the nose bars 39 and 41 providing a smoothly rounded surface for the belt to translate and transition around as the belt is being pulled. When the left side apron 34a is moving from open to closed, nose bar 39 defines the leading edge of the apron and nose bar 41 defines the trailing edge. Conversely, when the apron 34 is moving from closed to open, nose bar 41 is the leading edge and nose bar 39 is the trailing edge.

There are numerous different types of materials that function well for the belts used in the present invention. Generally speaking, any flexible membrane or sheet material of nearly any type that has minimal stretch can function as the belts. Suitable materials include reinforced polymer films, canvas and materials having similar functional attributes.

A suitable belt 44 includes for example a belt manufactured by Splawn and sold under the designation 2PM UO-V5. The opposite edges of the belt (i.e., the edges of the belt that extend across frame 12 parallel to the support members 37 are fixed to frame 12 in order to prevent deflection or distortion of the belt as the apron reciprocates. There are numerous manners in which the belt may be attached to the frame and preferably there are multiple attachment points along the width of the edges. For example, at attachment point 70 a loop may be formed in the belt across the entire width thereof and a rigid elongate rod may be inserted into the loop; the opposite ends of the rod are fixed to the vertical frame members and there may be numerous attachment points of the rod to the frame intermediate between the two ends. One corner 72 of the first belt 44 is fixedly attached to the frame 12 such as to vertical member 32 and does not move relative to movement of the chain and roller curtain. Likewise, the second corner of the first belt 44 is fixedly attached at 70 to horizontal member 17 of frame 12. The opposite corners of the first belt 44, which are not shown in the elevation views of FIGS. 4 and 5 are similarly fixedly attached to the vertical and horizontal members 31 and 19, respectively, of frame 12. Like or equivalent attachment techniques may be used at all of the belt corners.

As noted, the belt defines a sheet that effectively covers the effective width of the top and bottom surface of the roller apron 36 with fixed mounts at each end. As the roller chain 38 loop driving the left side apron 34a is moved in one direction the belt, fixedly attached at each of its corners to frame 12 is forced to follow apron movement. The combination of a retracting roller curtain along with a belt have its corners stationary results in an apparent stationary belt from the perspective of a bagged item supported on the apron assembly. Thus, as a bagged item sits on the apron floor, and the apron is opened (retracted) from the closed position, the roller curtain moves horizontally away from the center and then upwardly along the vertical portion of the L-shaped path, but the belt is pulled along the lower side of the roller support members 36 while simultaneously being retracted along with the roller curtain. This results in displacement of the belt with no relative movement between the upper, supporting surface of belt 44 and the bottom of the bagged item as the floor defined by the apron 34a is removed. This prevents bunching and tearing of the bagged item as the apron floor is retracted. Because the apron 34a includes plural roller support members 37, which are closely spaced relative to one another, and because the belt 44 effectively covers the entire effective supporting surface of the roller curtain 36, bagged items are entirely supported on a uniform surface without any void spaces in the supporting surface.

Synchronized, simultaneous, albeit opposite motivation of the right side apron half 34b occurs similarly in operation to the left side 34a as the apron motor 48 turns. Specifically, as sprocket 94 rotates, direct corresponding motion occurs in the second roller curtain chain 54. This chain also is directed into a generally L-shaped path via a bottom guide sprocket 77a, which directs the chain 54 downward from sprocket 94 and turns the chain 54 about 90-degrees toward the center of the apron to the center guide sprocket 79, which in turn reverses the chain about 180 degrees rearward to the return sprocket 75, which then directs the chain upward vertically back to sprocket 94. A chain tensioner 81 enables mechanical tensioning of the chain 54. A second roller curtain 50 couples to the chain so that the roller curtain travels in the same direction of the chain. A second belt 58 includes fixed attachment points at its four corners, and is attached to the roller chain 54 in the same manner as described previously with respect to belt 44. Reference numbers 71 and 76 are fixed attachment points and the duplicate of mounting points 70 and 72 on the opposite side (left side 34a). The right side apron half 34b operates identically to, and simultaneously but oppositely to the left side apron half 34a.

An additional feature of the first preferred embodiment of the present invention includes a compaction system adapted to cooperatively function with the center-opening apron assembly 34. Specifically contemplated, a center clamping and compaction system identified generally with reference number 100 in FIG. 1 includes two opposing x-direction compaction arms, clamp bar 62a and 62b, and two opposing y-direction compaction arms, clamp bar 63a and 63b. The relative x and y directions are illustrated with arrows x and y in FIG. 1. Each x-direction compaction arm is arranged at a right angle to each y-direction compaction arm and the x and y-direction clamping arms are configured to operate simultaneously or independently to clamp bagged items supported on the floor defined by belts 44 and 58.

In the first preferred embodiment and as FIGS. 1-3 illustrate, the compaction system includes only one cylinder for driving each of the clamp bars or conditioning bars 62 and 63 in the x-direction and the y-direction, respectively. However, a second preferred embodiment includes one cylinder for each of the four sides (two x-direction, two y-direction). Accordingly, the various components of the first preferred embodiment anticipate the inclusion of such an arrangement. As such, the components in the compaction system 100 will be discussed relative to a single cylinder per direction system.

Both the x-direction and y-direction clamp arms are independently controlled by a PLC to provide flexibility for many varied clamping arrangements. However, an explanation of the operation of the system can be simplified by referencing only one direction (for example, the x-direction), it being understood that the other (y-direction) works in substantially the same manner with nearly identical or identical components.

Corresponding to the x-direction arms 62a and 62b, a x-direction compaction cylinder 64b is fixedly attached to the a first clamp sliding shoe 101a at one end of the cylinder, and at the opposite end of the cylinder, the cylinder strut fixedly couples to a second clamp sliding shoe 101b. The first clamp sliding shoe 101a fixedly couples to a first end of one x-direction arm 62a and the second clamp sliding shoe 101b couples to a first end of the other x-direction arm 62b. The second ends of arms 62a and 62b similarly couple to their own respective second side first clamp sliding shoe 102a and second side second clamp sliding shoe 102b. In a second preferred embodiment, the second side first and second clamp sliding shoes couple to a second x-direction cylinder. However, as FIG. 1 illustrates the first preferred embodiment having only one x-direction cylinder, the movement of the second side first and second clamp sliding shoes 102a and 102b must be motivated by a synchronization mechanism. Accordingly, a first side first x-direction synchronization chain 69 couples to the first side first clamp sliding shoe 101a at a half-chain loop mount. This first side first synchro chain 69 is directed over a synchro sprocket 115 mounted to the vertical support 29 and returns to couple to the second clamp sliding shoe at a chain mount thereon. In a similar manner, the second clamp sliding shoe 101b couples to a second, first-side synchro chain at a second chain mount on the second shoe, and is directed to a second synchro sprocket mounted on vertical support 30 (not shown). The second synchro chain on the first x-direction side further connects to a second chain mounting point on the first clamping shoe. Thus, a full chain loop is formed using both clamping shoes and both synchro chains. Further, a first x-direction synchronization shaft engages with the first synchro sprocket and a second x-direction synchronization shaft engages the second synchro sprocket. The first shaft spans from vertical support 30 to vertical support 31. At the terminus on support 31, the shaft drives a corresponding sprocket, which drives, in turn, a corresponding chain loop as just described on the first x-direction side. The second synchronization shaft spans from support 29 to span 32 and similarly has an associated sprocket driving the same chain loop. Thus, as the cylinder 64b extends to an open position, the first side movement of the first side chain loop and first side first and second shoes (which couple to the compaction arms 62a and 62b) results in simultaneous synchronized movement on the second side x-direction.

Similarly, the y-direction clamping arms 63a and 63b have controlled movement at both arm ends from corresponding first y-side and second y-side first and second clamping shoes. So, as cylinder 64a extends, a synchronization chain loop comprising two chain segments, each coupled to the first y-side first and second shoes drive sprockets at either end. The sprockets turn shafts 20 and 21, which in turn rotate sprockets 104 and 120. Sprocket 120 pulls a first chain segment 110 having a first end coupled to the first clamping shoe 116 at the first chain mount 118, while the second end of the chain segment 110 couples to the second clamping shoe 106. A second chain segment 111 at one end couples to the second clamping shoe 106 at a clamp mount 102 and extends around sprocket 104, returning to a corresponding clamp mount 112 on the first shoe 114. The first clamp shoe couples to the second end of y-direction clamp arm 63b and the second clamp shoe 106 couples to the second end of y-direction clamp arm 63a.

As illustrated in the associated figures, the x-direction compaction arms 62a and 62b comprise three generally parallel bars coupled via a pair of oppositely disposed linking plates. Intermediate guide members 68 ensure appropriate spacing and enable the three parallel bars to remain appropriately spaced apart during relative movement of the clamping arms. The guide members 68 slideably receive each bar so as to not hinder the extension and retraction of the x-direction compaction arm. The y-direction compaction arms include two parallel bar members arranged to fit in-between the three x-direction bars and share common guide members, which further maintain the proper spacing and slideably receive each and all bar members. Although this particular arrangement is contemplated in this first preferred embodiment, it would be understood that more or less parallel bar members could work equally well and may depend on the application or size of bagged items, for example.

Operation of the apparatus 10 will now be explained in the context of a robot that is configured for picking individual bags and placing the bags in apparatus 10. A robot (not shown but well known in the art) picks and places a layer grouping of plural bags on the apron support, which is defined by the belt 44 of left side 34a and belt 58 of right side 34b apron halves in their closed positions, in either a tight grouping or loose grouping dependent on the product being handled. As shown in FIG. 4, when the apron support is in the closed position the leading edge nose bars and therefore the belts 44 and 58 are in close proximity to one another. This results in the combined left and right halves defining a support surface having essentially a unitary surface, and this provides a very unitary support for bagged items. Because the roller support members 37 and 51 have their opposite ends supported by the attachment to the drive chains, the entire apron support is very stable and secure and does not deflect under the weight of bagged items placed on the support.

As noted previously, the belts 44 and 58 effectively cover the entire width of the top and bottom surface of the roller apron and therefore provide a uniform surface on which the items are supported. In all instances, bagged items are placed by the robotic pick and place apparatus on the support surface defined by the apron assembly; as used herein, the term apron support surface refers to that portion of the belts 44 and 58 that define a bagged item accumulation zone upon which the bagged items are arranged. With reference to FIGS. 1 and 2, the apron support surface is therefore that portion of the combined left and right sides interiorly of the four compaction arms 62a, 62b and 63a, 63b. Some bag products must be stacked slightly overlapping each other to create the desired finished load and others desire an edge to edge finished layer configuration. Once the layer is constructed by picking and placing items the layer head defined by apparatus 10 is pre-positioned or positioned immediately above the previously deposited layer, or if the layer is the first (or lowermost) layer, above the surface onto which the layer will be deposited (such as a pallet or a slip sheet). If side-clamping conditioning is appropriate for the product the four-sided clamps are activated to condition the layer into a tight grouping. If the layer was already built in a tight or tight overlapped grouping clamp or conditioning actuation may be unnecessary. The apron is then removed by moving left side 34a and right side 34b from the closed position (FIG. 4) to the open position (FIG. 5) and as there is no relative movement between the apron supporting surface and the item bottom the layer is deposited onto the underlying surface without appreciable change in condition that existing prior to deposit. If clamps were used to condition the layer in most instances they will be retracting while the layer is deposited as there is no need for clamping to resist friction of apron removal.

The underlying surface with a newly deposited layer of bags is then moved vertically downward, away from apparatus 10, and the apron is then moved into the closed position (FIG. 4). The robot picks and places plural bags in a predetermined pattern on the belts 44 and 58 and the sequence is repeated until a full stack has been assembled.

The above method is describe for bag palletizing, but as noted previously the advantages of no relative movement between the supporting apron and the bottom of items being palletized are equally advantages for any product, but especially for example unstable tall products, very heavy products or products that are overwrapped with shrink film that sometimes tears from the friction of apron removal.

While the present invention has been described in terms of a preferred embodiment, it will be appreciated by one of ordinary skill that the spirit and scope of the invention is not limited to those embodiments, but extend to the various modifications and equivalents as defined in the appended claims.

We claim:

1. Apparatus for palletizing items, comprising:
an apron support surface for supporting plural items, said apron support surface defined by first and second support curtains reciprocally movable relative to one another along a support curtain movement path from a first position in which the apron support surface is closed and a second position in which the apron support surface is open, each of said support curtains defined by
plural support members extending transverse to the support curtain movement path and each having their opposite ends supported, and
a belt extending over the plural support members;
wherein when said apron support surface is in the closed position the belts of the first and second support curtains define an item accumulation zone having a substantially uniform surface.

2. The apparatus according to claim 1 wherein each of the support members is defined by an elongate roller member that is rotatable about its longitudinal axis.

3. The apparatus according to claim 1 wherein each of the first and second support curtains has an upper surface and a lower surface and the belt substantially covers the upper and lower surfaces.

4. The apparatus according to claim 3 wherein as the first and second support curtains move from the first position toward the second position, items supported on the apron support surface are deposited onto a surface underlying the apron support surface.

5. The apparatus according to claim 4 wherein there is no relative movement between the belts of the first and second support curtains and items supported on the support curtains as the support curtains move from the first position toward the second position.

6. The apparatus according to claim 6 wherein each belt is defined by a sheet having four corners and wherein each corner is fixed and immovable relative to the first and second support curtains.

7. The apparatus according to claim 6 wherein the roller curtain movement path is non-linear.

8. The apparatus according to claim 7 wherein the roller curtain movement path includes a horizontal portion and a vertical portion.

9. The apparatus according to claim 8 wherein the support curtain movement path is L-shaped.

10. The apparatus according to claim 1 further comprising a first pair of clamping arms, one located on either side of the apron support surface and operable for manipulating items on the apron support surface in a direction parallel to the roller curtain movement, and a second pair of clamping arms, one located on either side of the apron support surface and operable for manipulating items on the apron support surface in a direction transverse to the roller curtain movement.

11. The apparatus according to claim 10 wherein the first and second pairs of clamping arms are simultaneously operable.

12. Apparatus for palletizing items, comprising:
an apron support surface for supporting plural items, said apron support surface defined by at least one flexible curtain movable along a non-linear path from a first position in which the apron support surface is adapted for supporting plural items and a second position in which the apron support surface is adapted for depositing said plural items onto a surface below said apron support surface, said at least one flexible curtain defined by plural support members extending transverse to the path and each support member having opposite ends supported, said at least one flexible curtain further comprising a belt extending over said support members.

13. The apparatus according to claim 12 wherein the apron support surface has an upper surface and a lower surface and the belt extends over substantially all of the upper and lower surfaces.

14. The apparatus according to claim 12 comprising two flexible curtains configured for reciprocal movement between a first position and a second position, each of said flexible curtains having a leading edge and wherein in the first position the leading edges of the first and second flexible curtains are in close proximity to one another.

15. The apparatus according to claim 14 wherein in the first position the apron support member is substantially a unitary surface.

16. The apparatus according to claim 15 wherein each of the first and second flexible curtains moves through a non-liner path as the curtains reciprocate between the first and second positions.

17. The apparatus according to claim 12 in which the flexible curtain is defined by plural roller members, each having a longitudinal axis oriented transverse to the path and each independently rotatable about the longitudinal axis.

18. Apparatus for palletizing items, comprising:
a frame having horizontal support members vertical support members;
a support apron movable along a path between a closed position in which the support apron is disposed between the horizontal support members to define an item accumulation zone when the support apron is in the closed position, and an open position, said support apron defined by first and second curtains, each of said first and second curtains defined by plural supports having a longitudinal axis transverse to the path and having opposite ends supported by the horizontal support members, and each of said first and second curtains further defined by a belt extending over the plural supports.

19. The apparatus according to claim 18 wherein when the support apron is in the open position at least a portion of each of the first and second curtains is oriented vertically.

20. The apparatus according to claim 18 including clamping means movable along transverse axes to condition items in the item accumulation zone.
